(19) United States
(12) Patent Application Publication
(10) Pub. No.: US 2007/0284197 A1
(43) Pub. Date: Dec. 13, 2007

(54) Rotary oscillation damper for a rotary shaft, particularly of a gearbox or an internal combustion engine

(75) Inventors: Wolfgang Kiener, Berlin (DE); Eduard Gerum, Rosenheim (DE)

Correspondence Address: CROWELL & MORING LLP;INTELLECTUAL PROPERTY GROUP, P.O. BOX 14300, WASHINGTON, DC, 20044-4300, US

(73) Assignees: Hasse & Wrede GmbH, Berlin (DE); Knorr-Bremse Systeme Fuer Nutzfahrzeuge Gmbh, Muenchen (DE)

(21) Appl. No.: 11/806,654

(22) Filed: Jun. 1, 2007

Related U.S. Application Data
(63) Continuation of application No. PCT/EP05/12510, filed on Nov. 23, 2005.

(30) Foreign Application Priority Data
Dec. 1, 2004 (DE) 10 2004 057 987.3

(51) Int. Cl. F16D 65/38

(52) U.S. Cl. 188/73.35

(57) ABSTRACT

A rotary oscillation damper of a motor-driven vehicle, includes a substantially rotationally symmetrical base part and a damping member. The rotary oscillation damper is constructed to form part of a brake, particularly a parking brake, wherein brake shoes or brake pads, which are arranged on the vehicle side in a fixed manner, can be pressed against the base part or parts which are connected thereto such as rings or flanges.

### CROSS-REFERENCE TO RELATED APPLICATIONS

This application is a continuation of PCT International Application No. PCT/EP2005/012510, filed on Nov. 23, 2005, which claims priority under 35 U.S.C. § 119 to German Application No. 10 2004 057 987.3, filed Dec. 1, 2004, the entire disclosures of which are expressly incorporated by reference herein.

### BACKGROUND AND SUMMARY OF THE INVENTION

The present invention relates to a rotary oscillation damper for a rotary shaft, particularly of a gearbox or an internal combustion engine of a vehicle.

In vehicle gearboxes, oscillations occur due to excitation by the periodic combustion sequences in the engine. In order to reduce these oscillations, either flywheel masses are used, for example on a clutch plate for coupling the gearbox to a drive shaft, or else rotary oscillation dampers of a known type are used.

The present invention is based on the object of developing a rotary oscillation damper in a simple and inexpensive manner, in such a way that the rotary oscillation damper performs a further function, which is necessary for a vehicle, in order to reduce the manufacturing costs of a vehicle.

According to the invention, this object is achieved in that the rotary oscillation damper is adapted to form a brake, in particular a vehicle parking brake, wherein brake shoes or brake pads, which are arranged in a stationary manner on the vehicle side, can be pressed against the base part, in particular the damper housing, or against parts which are connected to it such as rings, flanges or the like. Instead of a damper housing, the rotary oscillation damper can also be configured as an annular base part, on which another damping element is arranged, for example an elastomer ring. If a damper housing is mentioned in the following text, it relates to this extent to the particularly preferred exemplary embodiment.

As a result of this structurally comparatively simple measure, a rotary oscillation damper can also assume a brake function for a corresponding vehicle. It is not required here to manufacture and to mount a completely independent brake, as a substantial constituent part of a brake comprises the damper housing as a result of the construction according to the invention.

The invention, therefore, also provides a combination of a rotary oscillation damper and a brake, in particular a drum brake, which can preferably be used as a parking brake for the vehicle.

The construction according to the invention may preferably be used as what is known as a parking brake. Here, the brake can be configured as a drum brake or as a disk brake.

The configuration as a drum brake is particularly advantageous, for example for the case of use as a parking brake, because the drum brake has a high mass moment of inertia as a result of the concentration of the mass on the external diameter, and is additionally of relatively small design as a result of the possibility for self-energizing. The action of the rotary oscillation damper is also improved by the possibility, which is then present, of simultaneous braking. The damping behavior can then be implemented adaptively within certain limits. The rotary oscillation damper, is therefore, no longer a simple mechanical system with unchangeable characteristics, but can be adapted to the current requirements within limits by way of, for example, electronic regulation of the brake.

As parking brakes of the above-mentioned design type are often actuated by an electric motor, electronic regulation is necessary in the case of a setpoint generator. The characteristics of the rotary oscillation damper can then also be varied via this mechanism.

The regulation preferably takes place in an electronic control unit, which may be integrated into a unit already present, for example into the gearbox controller of the vehicle.

Further advantageous features of the invention are described herein.

Other objects, advantages and novel features of the present invention will become apparent from the following detailed description of the invention when considered in conjunction with the accompanying drawings.

### BRIEF DESCRIPTION OF THE DRAWINGS

FIG. 1 is a half cross-section of a rotary oscillation damper adapted to form a brake in accordance with the present invention;

FIG. 2 is a half cross-section of a second embodiment of a rotary oscillation damper adapted to form a brake according to the present invention;

FIG. 3 is a half cross-section of a third embodiment of a rotary oscillation damper adapted to form a brake according to the present invention;

FIG. 4 is a half cross-section of a fourth embodiment of a rotary oscillation damper adapted to form a brake according to the present invention;

FIG. 5 is a half cross-section of a fifth embodiment of a rotary oscillation damper adapted to form a brake according to the present invention; and

FIG. 6 is a half cross-section of a sixth embodiment of a rotary oscillation damper adapted to form a brake according to the present invention.

### DETAILED DESCRIPTION OF THE DRAWINGS

Unless otherwise noted, in FIGS. 1 to 6, the designation 1 denotes in each case a rotary oscillation damper for a gearbox of an engine-driven vehicle, the rotary oscillation damper including here, in preferred embodiments, in each case one damper housing 2 having a receptacle chamber 3 for a damping member as base part, for example in the form of a flywheel ring 4 which is held in a bearing 5 and is surrounded in its shear gap (at 3) by viscous fluid. The receptacle chamber 3 is closed by a cover 6.

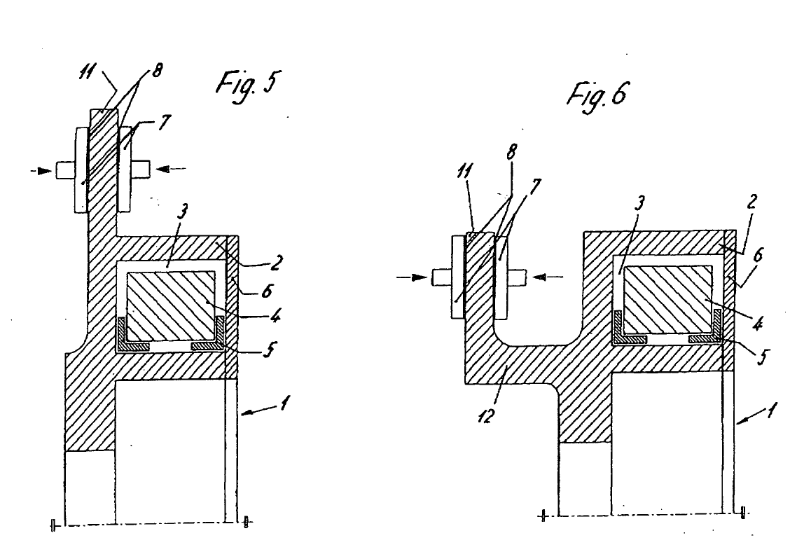

This construction is identical in all exemplary embodiments which are shown. It is likewise identical in all exemplary embodiments which are shown wherein the rotary oscillation damper 1 is used as a brake surface, it being possible for the exemplary embodiments according to FIGS. 1 to 4 to be denoted as drum brakes and the exemplary embodiment according to FIGS. 5 and 6 as disk brakes. In order to apply tensile stress to the brake linings 8, a brake application mechanism (not shown here) is used, as is known per se in drum brakes or disk brakes, and which is adapted here to the particular conditions.

In the exemplary embodiments according to FIGS. 1 to 4, radially adjustable brake shoes 7 have a brake lining 8. The brake shoes are fastened in a stationary manner (that is to say, they do not rotate) on the vehicle side (not shown) and are pressed against the damper housing 2 or against rings 9 which are, preferably, manufactured integrally with the damper housing 2.

For instance, in the exemplary embodiment according to FIG. 1, the damper housing 2 is extended on its end side which faces away from the cover 6 by a ring 9, which protrudes in the axial direction. The above-mentioned brake shoes 7 can be pressed against this ring 9 on the inside, but also as an alternative on the outside.

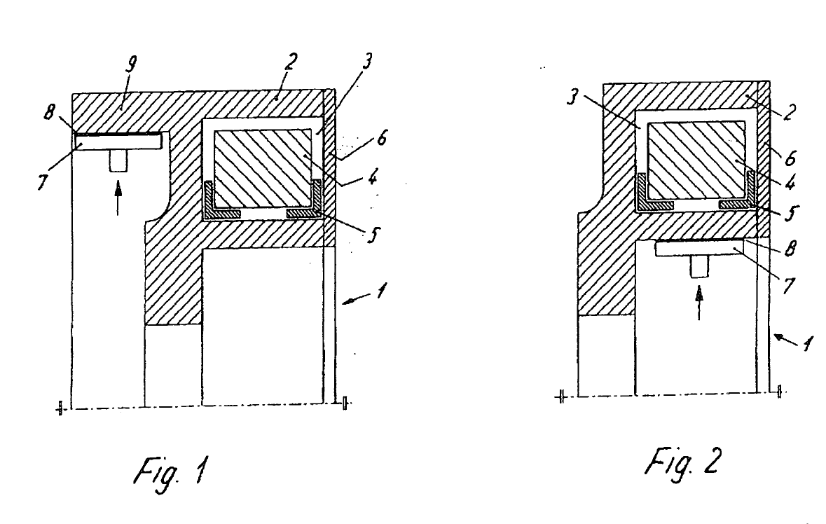

In the exemplary embodiment according to FIG. 2, brake shoes 7 having brake linings 8 are pressed directly against an inner circumferential face of the damper housing 2.

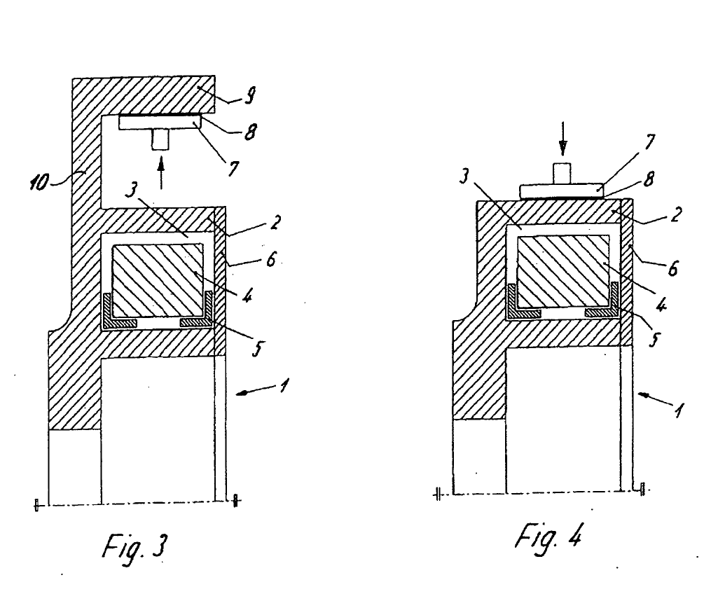

In the exemplary embodiment according to FIG. 3, a ring 9, which is formed integrally on the damper housing 2, is held by an annular flange 10 protruding radially beyond the damper housing 2. The annular flange 10, in turn, adjoins the damper housing 2 integrally. Brake shoes 7 having brake linings 8 are, in turn, pressed against the inner side of the ring 9.

As an alternative to this, the brake shoes 7 could also be pressed against the outer side of the ring 9.

In the exemplary embodiment according to FIG. 4, the brake shoes 7 having the brake linings 8 are pressed directly against the outer ring face of the damper housing 2.

In the exemplary embodiments according to FIGS. 1 to 4, the rings 9 or the damper housing 2 form the brake drum of a drum brake.

In the exemplary embodiments of the invention according to FIGS. 5 and 6, which show a construction of the damper housing 2 as a disk brake, flanges 11 which extend radially with respect to the rotational axis of the damper housing 2 so as to form brake disks (these can also be of frustoconical configuration), are formed integrally on the damper housing 2, in which brake pads 7 having brake linings 8 can be pressed against two end sides which lie opposite one another.

Here, in the exemplary embodiment according to FIG. 5, the flange 11 is formed integrally and directly on the damper housing 2 in a radially protruding manner.

In the exemplary embodiment according to FIG. 6, the flange 11 is formed integrally on an axially protruding bearing ring 12, which is formed integrally on the damper housing 2. The bearing ring 12 has a smaller diameter than the external diameter of the damper housing 2. The flange 11, which is held by the bearing ring 12, extends again radially in the external direction of the damper housing 2 and has an external diameter which is approximately identical to the external diameter of the damper housing 2. The differences in the exemplary embodiments 5 and 6 therefore lie as far as possible in the fact that, in the exemplary embodiment according to FIG. 5, the flange 11 which is used as a brake disk protrudes beyond the outer ring face of the damper housing 2, while, in the exemplary embodiment according to FIG. 6, the flange 11 lies approximately in the external diameter region of the damper housing 2.

In FIGS. 5 and 6, the flanges 11 in practice form the brake disk of a disk brake.

The brake shoes/pads 7 are preferably actuated by electric motor. Electric setpoint generators are required for the corresponding electric motors, it being possible for an electronic control unit to preferably be integrated for this purpose into a unit which is already present, for example the gearbox controller of a vehicle. Hydraulic or pneumatic actuation may also be performed.

The brake can, therefore, also be used for setting the damping behavior of the rotary oscillation damper.

In the exemplary embodiments shown, the rings or flanges, against which brake shoes/pads can be pressed, are manufactured in one piece with the damper housing 2. As a variation of this, it goes without saying that it is also contemplated for corresponding rings or flanges to be connected fixedly as separate components to the damper housing 2.

### TABLE OF REFERENCE NUMBERS

1 Rotary oscillation damper
2 Damper housing
3 Receptacle space
4 Flywheel ring
5 Bearing
6 Cover
7 Brake shoe/pad
8 Brake lining
9 Ring
10 Annular flange
11 Flange(s)
12 Bearing ring

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A rotary oscillation damper of a motor-driven vehicle, comprising:
a substantially rotationally symmetrical base part operatively configured to include a damper housing having a receptacle chamber;
a damping ring arranged in the receptacle chamber;
wherein the rotary oscillation damper is operatively configured to form a brake component, at least one surface of the base part being configured to interact with a brake lining that presses against the surface.

2. The rotary oscillation damper as claimed in claim 1, wherein the brake lining presses against a surface of the damper housing.

3. The rotary oscillation damper as claimed in claim 1, wherein the brake lining presses against a part protruding from the damper housing.

4. The rotary oscillation damper as claimed in claim 3, wherein the part comprises one of a ring and a flange.

5. The rotary oscillation damper as claimed in claim 1, wherein the brake lining presses against an outer circumferential face of the damper housing.

6. The rotary oscillation damper as claimed in claim 1, wherein the brake lining presses against an inner circumferential face of the damper housing.

7. The rotary oscillation damper as claimed in claim 4, wherein the ring protrudes one of axially or radially beyond the damper housing, the ring being operatively configured such that the brake lining is pressable on either an interior or exterior side thereof.

8. The rotary oscillation damper as claimed in claim 1, wherein a radially extending flange is connected to the damper housing, the radially extending flange being operatively configured such that brake linings are, respectively, pressable against opposing side faces of the flange.

9. The rotary oscillation damper as claimed in claim 8, wherein the flange protrudes circumferentially beyond the damper housing.

10. The rotary oscillation damper as claimed in claim 8, wherein the flange is held by a bearing ring, the bearing ring protruding axially beyond the damper housing.

11. The rotary oscillation damper as claimed in claim 1, further comprising a brake application device having assigned thereto a force generator, the brake application device actuating brake pads or brake shoes having the brake lining.

12. The rotary oscillation damper as claimed in claim 11, further comprising a control unit for controlling the force generator, the control unit being integrated into a vehicle-side unit.

13. The rotary oscillation damper as claimed in claim 12, wherein the vehicle-side unit is a gearbox controller.

14. The rotary oscillation damper as claimed in claim 12, wherein the force generator is an electric motor.

15. The rotary oscillation damper as claimed in claim 12, wherein the force generator is operatively configured to the hydraulically or pneumatically operated.
